(19) United States
(12) Patent Application Publication
(10) Pub. No.: US 2007/0206838 A1
(43) Pub. Date: Sep. 6, 2007

(54) Time synchronous biometric authentication

(76) Inventor: Julie E. Fouquet, Portola Valley, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/359,258

(22) Filed: Feb. 22, 2006

(51) Int. Cl. G06K 9/00

(52) U.S. Cl. 382/115; 340/5.52; 455/411

(57) ABSTRACT

Systems and methods of time synchronous biometric authentication are described. In one aspect, a message is received on a mobile telephone control channel. A current reference time is determined from the received message. Personal biometric data of a user is encoded based on the current reference time. The encoded personal biometric data is transmitted. In another aspect, an authentication system includes a receiver, a processor, and a transmitter. The receiver receives a message on a mobile telephone control channel. The processor determines a current reference time from the received message and encodes personal biometric data based on the current reference time. The transmitter transmits the encoded personal biometric data.

### BACKGROUND

A typical goal of authentication is to determine whether or not a person seeking access to information, resources, or services has a right to such access. Although mechanical locks traditionally have been used to limit access to property and physical resources, electronic locks that are opened with encoded key cards are replacing such mechanical locks for controlling access to rooms or electronic resources, such as automatic teller machines. The security provided by an electronic lock oftentimes is increased by requiring a person to not only possess an appropriate electronic key card but also enter a password or a personal identification number (PIN) before access is granted to particular information, resources, or services.

Biometric authentication methods, which are based on a unique physiological or behavioral characteristic, may be used to eliminate the need to remember many different passwords and PINs. In addition, biometric authentication provides a higher level of security than passwords or PINs because the authentication is based on biometric data, which is difficult to copy. Among the common types of biometric data that may be used for authentication purposes are: fingerprints; patterns on the retina or iris of the eye; patterns on the face; hand geometry; voice patterns; and handwritten signatures. Biometric authentication involves comparing biometric data that was recently acquired from a person to one or more previously registered versions of the same biometric data. The person is determined to be the same as a previously enrolled person if there is a match between the currently acquired version and a previously registered version of the biometric data. Authentication may involve verification (i.e., confirming that the currently acquired biometric data matches a registered version of the biometric data associated with the person) or identification (i.e., selecting one of many previously registered versions of biometric data that best matches the currently sensed biometric data).

Although the use of biometric data for authentication provides many conveniences and advantages, biometric data cannot be replaced or reissued in the same way as an electronic card or a PIN. Therefore, extreme care may be taken to reduce the opportunity for theft of a person's biometric data for illicit purposes. What is needed is a biometric authentication approach that can securely protect personal biometric data without unduly increasing the cost or inconvenience to the user.

### SUMMARY

In one aspect, the invention features an authentication method in accordance with which a message is received on a mobile telephone control channel. A current reference time is determined from the received message. Personal biometric data of a user is encoded based on the current reference time. The encoded personal biometric data is transmitted.

In another aspect, the invention features an authentication system that includes a receiver, a processor, and a transmitter. The receiver receives a message on a mobile telephone control channel. The processor determines a current reference time from the received message and encodes personal biometric data based on the current reference time. The transmitter transmits the encoded personal biometric data.

Other features and advantages of the invention will become apparent from the following description, including the drawings and the claims.

### DESCRIPTION OF DRAWINGS

FIG. 1 is a diagrammatic view of an embodiment of a time synchronous biometric authentication system that includes a biometric access device, an authentication authority, a synchronizing time source, and a mobile telephone network.

FIG. 2 is a flow diagram of an embodiment of a method implemented by an embodiment of the biometric access device shown in FIG. 1.

FIG. 3 is a flow diagram of an embodiment of a method implemented by an embodiment of the authentication authority shown in FIG. 1.

FIG. 4 is a block diagram of an embodiment of the biometric access device shown in FIG. 1.

FIG. 5 is a block diagram of an embodiment of the authentication authority shown in FIG. 1.

FIG. 6A is a flow diagram of an embodiment of a method of encoding personal biometric data.

FIG. 6B is a flow diagram of an embodiment of a method of authenticating a user based on personal biometric data encoded in accordance with the method of FIG. 6A.

FIG. 6C is a flow diagram of an embodiment of a method of authenticating a user based on personal biometric data encoded in accordance with the method of FIG. 6A.

FIG. 7A is a flow diagram of an embodiment of a method of encoding personal biometric data.

FIG. 7B is a flow diagram of an embodiment of a method of authenticating a user based on personal biometric data encoded in accordance with the method of FIG. 7A.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

I. General Framework

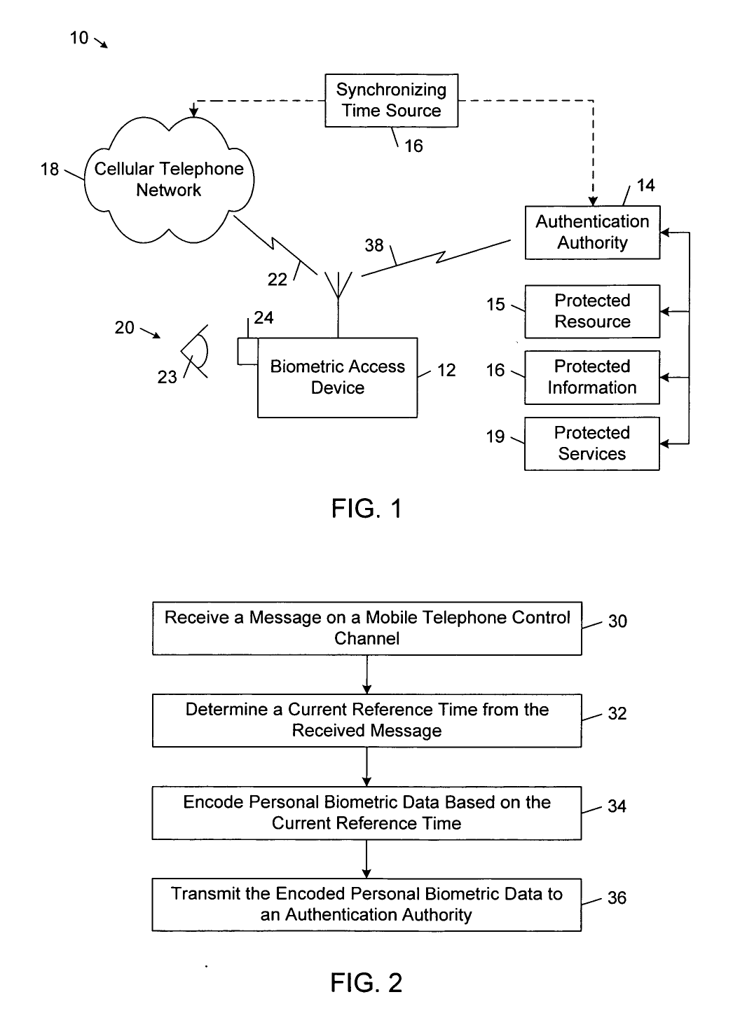

FIG. 1 shows an embodiment of a time synchronous biometric authentication system 10 that includes a biometric access device 12, an authentication authority 14, a synchronizing time source 16, and a mobile telephone network 18. The biometric access device 12 may be used, for example, to access a protected resource 15 (e.g., an enclosed space, such as a building, a room, an automobile, a safe deposit box, and a computer), protected information 17 (e.g., bank account information and medical records), or protected services 19 (e.g., withdrawal of money from an automatic teller machine). In some implementations, the authentication authority 14 is incorporated into the provider of the information 17, the resource 15, or services 19. In other implementations, the authentication authority 14 is an independent entity that provides an authentication service to other entities controlling access to the information 17, resources 15, or services 19 sought by the user 12. In these embodiments, the authentication authority may be located close to or far from these other entities.

As explained in detail below, the time synchronous biometric authentication system 10 authenticates a user 20 in a way that securely encodes the user's personal biometric data with unique, dynamic, and precise current time information that is extracted from messages 22 that are transmitted by the mobile telephone network 18 on one or more mobile (e.g., cellular or cordless) telephone control channels. The use of such unique, dynamic encoding of the user's personal biometric data significantly reduces the risk of theft of this information. In addition, the infrastructure, protocols, processes, and messages containing the current time information already exist in many areas of the United States and other countries. For example, some digital/PCS systems (e.g., the IS-95 CDMA system) include base stations that broadcast the precise local time on one of several control channels. Therefore, the time synchronous biometric authentication system 10 readily may be implemented without requiring any changes to existing mobile telephone infrastructures, which provide essentially free access to the precise time information. The biometric access device 12 also may obtain the precise current time information using readily available and pervasive mobile telephone receivers, which are significantly less expensive than self-contained precision clock circuits and other types of receivers, such as GPS receivers. In some embodiments, the biometric access device 12 may obtain the precise current time information from a cordless telephone base station over a cordless telephone control channel.

In some embodiments, a user 20 initially enrolls with the authentication authority 14 by presenting a unique personal physiological pattern or behavioral characteristic to the authentication authority 14. The presented pattern may be any type of unique physiological or behavioral characteristic that is unique to the user, including a fingerprint, a pattern on the retina or iris of the user's eye, a pattern on the user's face, a geometric pattern of the user's hand, a voice pattern, and a handwritten signature. The authentication authority 14 processes the pattern presented by the user 20 and stores the resulting biometric data in the form of a biometric template, which may be stored by the authentication authority in a compressed or encrypted form. The authentication authority typically indexes the biometric template with a username or PIN that is assigned to the user 20 during the enrollment process.

In some embodiments, before being granted access to information, a resource, or a service, the user may be authenticated by the authentication authority 14. Each time the user wishes to have his or her identity authenticated, the user 20 presents to the biometric access device 12 the same unique personal physiological pattern or behavioral characteristic that the user 20 used to enroll with the authentication authority 14. In the exemplary embodiment shown in FIG. 1, the user 20 presents his or her eye 23 for retinal or iris scanning by a biometric sensor 24 of the biometric access device 12. The biometric access device 12 may store the biometric pattern acquired from the user in raw form (e.g., an image format) or it may process the acquired biometric pattern into a biometric template using the same or similar method that was used by the authentication authority 14 during the enrollment process.

FIG. 2 shows an embodiment of a method by which the biometric access device 12 encodes and transmits the user's personal biometric data to the authentication system 14.

The biometric access device 12 receives the message 22 from the mobile telephone network 18 on a mobile telephone control channel (block 30). Cellular telephone networks, for example, include base stations that provide services to respective geographic cells through control and voice channels. The control channels are used to indicate the presence of the base station, to notify subscriber units of incoming calls, and to assign voice channels to subscriber units. The base stations broadcast messages over the control channels. The biometric access device 12 retrieves information from the signals broadcast by a mobile telephone base station after establishing a physical layer synchronization with the base station.

At least some of the control channel messages contain time information from a precision time source that is represented schematically by the synchronizing time source 16 shown in FIG. 1. The synchronizing time source 16 may be any source of a standard time that is readily accessible by the mobile telephone network 18 and the authentication system. The synchronizing time source 16 may be located at a single physical location or distributed across many physical locations. The standard time may be, for example, the coordinated universal time (also referred to as “Greenwich Mean Time” or “world time”) or the international atomic time (TAI). Many mobile telephone networks broadcast time information that is synchronized to the coordinated universal time. Some mobile telephone networks send control messages that contain the current time as part of a “time set” command. For example, in digital cellular/PCS mobile telephone networks, each mobile telephone base station broadcasts, among other signals, control messages that contain the coordinated universal time, the current local time, the local time zone, and a flag for daylight savings time. Other mobile telephone networks, such as GSM networks and TDMA networks, broadcast status report messages on one or more control channels that contain timestamps that indicate the coordinated universal time at which the status report messages were generated.

After the message 22 has been received (block 30), the biometric access device 12 determines a current reference time from the received message 22 (block 32). The particular method that is used by the biometric access device 12 to determine the current reference time depends on the type of message 22 that is received from the mobile telephone network 18. In each case, however, the biometric access device 12 parses the message 22 for the time information contained in the message. In some embodiments, the current reference time determined by the biometric access device 12 corresponds to the coordinated universal time. In other embodiments, the current reference time determined by the biometric access device 12 may correspond to a local time, such as the local time where the biometric access device 12 is located or the local time where the authentication authority 14 is located, so long as the biometric access system 12 and the authentication system 14 encode and decode the personal biometric data using the same local time reference.

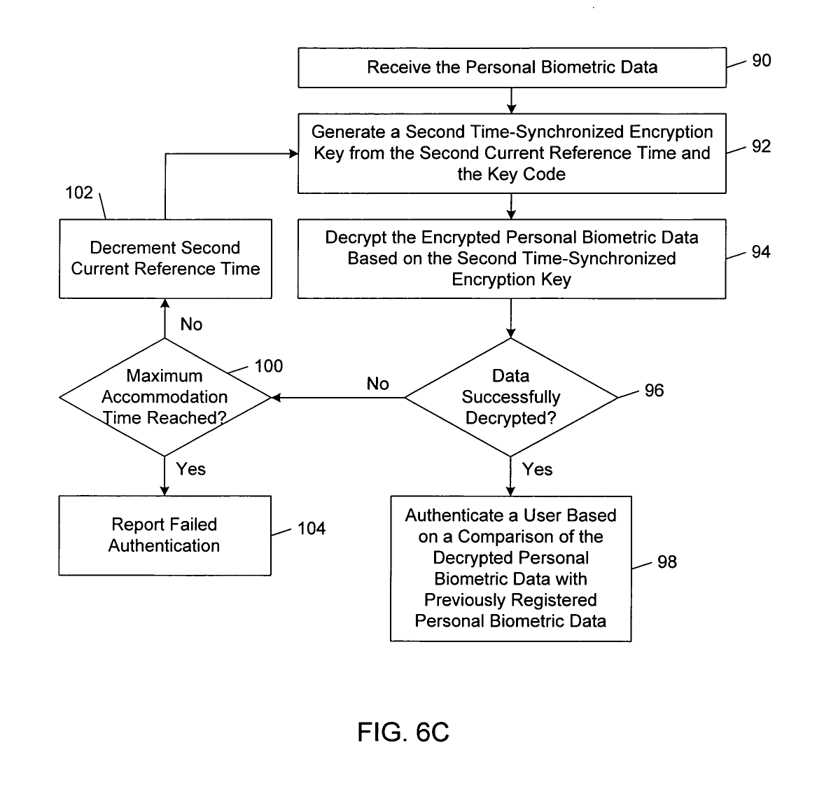

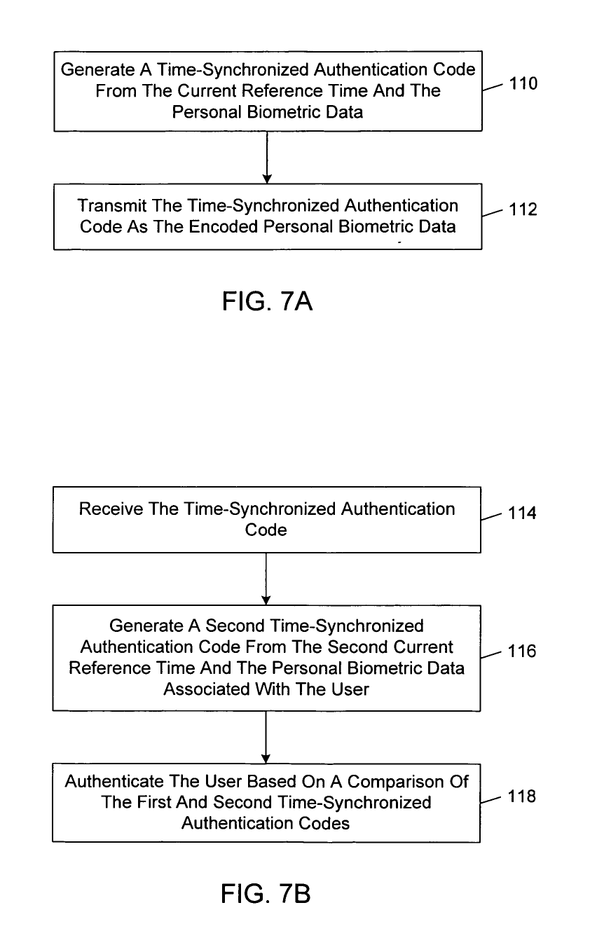

The biometric access device 12 encodes the personal biometric data based on the current reference time determined from the received message 22 (block 34). The biometric access device 12 may encode the personal biometric data in a wide variety of different ways that are time-synchronized with the authentication authority 14 based on the current reference time. In the embodiments described below in connection with FIGS. 6A and 6B, for example, the biometric access device 12 encodes the personal biometric data using a time-synchronized encryption key that is derived from the current reference time. In the embodiments described below in connection with FIGS. 7A and 7B, on the other hand, the biometric access device 12 encodes the personal biometric data in an authentication code that is generated from a combination of the personal biometric data and the current reference time.

After the personal biometric data has been encoded (block 34), the biometric access device 12 transmits the encoded personal biometric data 38 to the authentication authority (block 36). In the exemplary embodiment shown in FIG. 1, the biometric access device 12 transmits the encoded biometric data 38 over a wireless connection. In this embodiment, the biometric access device 12 may communicate with the authentication authority over one or more radio frequency (RF) or infrared (IR) communication channels in accordance with a particular communication protocol (or interface). The RF communication channels typically may lie within the 46-49 MHz frequency band, the 902-928 MHz frequency band, or the 2.4-2.48 GHz frequency band. The RF communication protocol may be any of the short-range radio communication protocols that have been proposed, including the Bluetooth communication protocol and the IEEE 802.11 (radio-LAN) communication protocol. Alternatively, the biometric access device 12 may communicate with the authentication authority over one or more long-range radio frequency (RF) communication channels (e.g., a conventional cellular or a 3G or 4G wireless communication channel) in accordance with a conventional RF communication protocol (e.g:, the Wireless Application Protocol (WAP)). An example of an IR communication protocol is the IrDA (Infrared Data Association) communication protocol. In other embodiments, the biometric access device 12 may transmit the encoded personal biometric data to the authentication authority over a wired connection with the biometric access device 12.

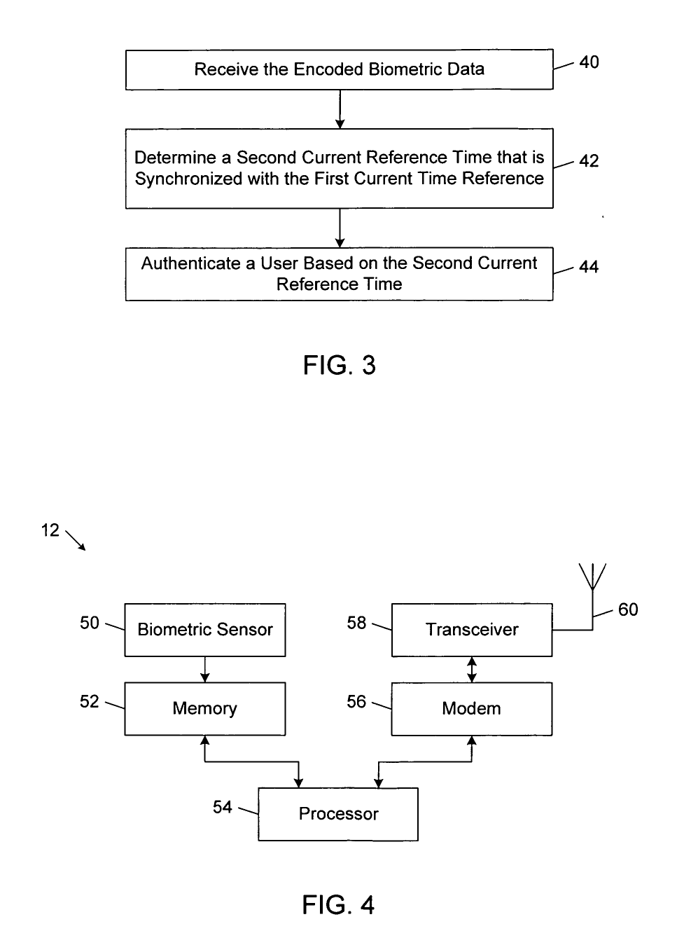

FIG. 3 shows an embodiment of a method by which the authentication authority 14 authenticates the user 20 based on the encoded biometric data 38 received from the biometric access device 12. In accordance with this method, the authentication authority 14 receives the encoded personal biometric data 38 from the biometric access device 12 (block 40). As explained above, the authentication authority 14 may receive the encoded personal biometric data 38 over a wired or wireless connection.

The authentication authority 14 determines a second current reference time that is synchronized with the first current reference time that was determined by the biometric access device 12 (block 42). In some embodiments, the authentication authority 14 determines the second current reference time by obtaining the standard time from the synchronizing time source 16 at the time the encoded biometric data is received from the biometric access device 12. Since the biometric access device 12 and the authentication authority 14 determine the first and second current reference times based on the standard time reported by the same synchronizing time source 16, the first and second current reference times should differ by only a transmission time delay. For high-speed communications over short distances, the transmission time delay should be small, in which case the second current reference time may be the time the encoded biometric data is received by the authentication authority 14. For low-speed communications or communications over long distances (e.g., communications over optical fiber links or satellite links), the transmission time delay may be significant, in which case, the authentication authority 14 accounts for the transmission time delay. In some embodiments, the authentication authority 14 accounts for the transmission time delay by selecting as the second current reference time progressively earlier times (i.e., earlier than the time the encoded biometric data is received) up to a predetermined maximum time interval from the receipt time.

The authentication authority 14 authenticates the user 20 based on the second current reference time (block 44). The authentication authority 14 may authenticate the user 20 in a wide variety of different ways based on the second current reference time and the encoded personal biometric data 38. In the embodiments described below in connection with FIGS. 6A and 6B, for example, the authentication authority 14 decodes the encoded personal biometric data 38 using a time-synchronized decryption key that is derived from the second current reference time and authenticates the user 20 based on a comparison between the decoded biometric data and the previously registered biometric data. In the embodiments described below in connection with FIGS. 7A and 7B, on the other hand, the authentication authority 14 authenticates the user 20 by generating a second authentication code from a combination of the previously registered personal biometric data and the second current reference time and comparing the first and second authentication codes.

In some embodiments, the authentication authority 14 may accommodate short time delays between the first and second current reference times by relaxing the required synchronization between the first and second current reference times. For example, the authentication authority 14 may allow a small specified period (e.g., a one minute) over which the first and second current reference times may differ while still being considered sufficiently synchronized for authentication purposes.

II. Exemplary Embodiments of the Biometric Access Device and the Authentication Authority

The biometric access device 12 may be implemented by or incorporated in any type of device. In some embodiments, the biometric access device 12 may be implemented as a mobile device, such as a mobile telephone, a cordless telephone, a portable memory device (e.g., a smart card), a personal digital assistant (PDA), a solid state digital audio player, a CD player, an MCD player, a camera, a game pad, a pager, and a laptop computer.

FIG. 4 shows an embodiment of the biometric access device 12 that includes a biometric sensor 50, a memory 52, a processor 54, a modem 56, a transceiver 58, and an antenna 60. The biometric sensor 50 may be any type of sensor capable of acquiring a unique physiological pattern or behavioral characteristic from the user 20. In some embodiments, the biometric sensor 50 is configured to capture one or more of the following from the user 20: a fingerprint; a pattern on the retina or iris of the user's eye; a pattern on the user's face; a geometric pattern of the user's hand; a voice pattern; and a handwritten signature. The memory 52 may be any type of non-volatile memory, including, for example, semiconductor memory devices, such as EPROM, EEPROM, and flash memory devices, magnetic disks such as internal hard disks and removable disks, magneto-optical disks, and CD-ROM. The processor 54 may be any type of data processor. The modem 56 is capable of modulating data signals from the processor 54 onto a carrier signal at a specified carrier frequency and to demodulate wireless signals received by the antenna 60. The transceiver 58 may be any type of half-duplex or full-duplex transceiver that is capable of transmitting signals between the modem 56 and the antenna 58.

In the illustrated embodiment, the modem 56 and the transceiver 58 are configured for communicating with the mobile telephone network 18 and the authentication authority 14 using one or more long-range radio frequency (RF) communication channels (e.g., a conventional cellular or a 3G or 4G wireless communication channel). In other embodiments, the biometric access device 12 includes an additional short range wireless communication system that is configured to establish communication links with the authentication authority in accordance with a low power communication protocol (e.g., the Bluetooth RF communication protocol or the IrDA infrared communication protocol).

The authentication authority 14 may be implemented any type of device or system that is capable of receiving the encoded biometric data 38 from the biometric access device 12, determining a second current reference time that is synchronized with the first current reference time that was determined by the biometric access device 12, and authenticating the user 20 based on the encoded biometric data 38 and the second current reference time. In some embodiments, the authorization authority 14 is implemented by a computer (e.g., a server computer, a personal computer, a portable computer, or a workstation computer) that includes a processing unit, a system memory, and a system bus that couples the processing unit to the various components of the computer. The processing unit may include one or more processors, each of which may be in the form of any one of various commercially available processors. Generally, each processor receives instructions and data from a read-only memory and/or a random access memory. The system memory typically includes a read only memory (ROM) that stores a basic input/output system (BIOS) that contains start-up routines for the computer, and a random access memory (RAM). The computer also may include a hard drive, a floppy drive, and CD ROM drive that contain respective computer-readable media disks that provide non-volatile or persistent storage for data, data structures and computer-executable instructions.

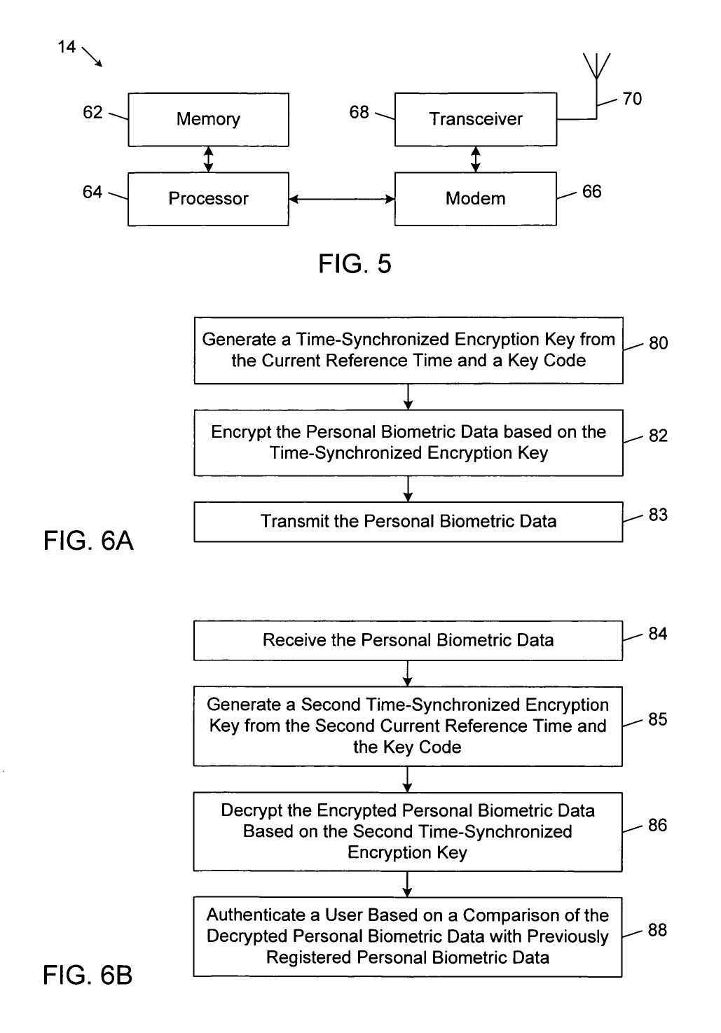

FIG. 5 shows an embodiment of the authentication authority 14 that includes a memory 62, a processor 64, a modem 66, a transceiver 68, and an antenna 70. The memory 62 may be any type of non-volatile memory, including, for example, semiconductor memory devices, such as EPROM, EEPROM, and flash memory devices, magnetic disks such as internal hard disks and removable disks, magneto-optical disks, and CD-ROM. The processor 64 may be any type of data processor. The modem 66 is capable of modulating data signals from the processor 64 onto a carrier signal at a specified carrier frequency and to demodulate wireless signals received by the antenna 70. The transceiver 68 may be any type of half-duplex or full-duplex transceiver that is capable of transmitting signals between the modem 66 and the antenna 68. A user may interact (e.g., enter commands or data) with the authentication authority 14 using a keyboard and a mouse. Other input devices (e.g., a microphone, joystick, or touch pad) also may be provided. Information may be displayed to the user on a monitor. The authentication authority 14 also may include peripheral output devices, such as speakers and a printer. The authentication authority 14 may be connected to one or more remote computers (e.g., workstations, server computers, routers, peer devices or other common network nodes) over a local area network (LAN) or a wide area network (WAN).

III. Exemplary Methods of Encoding the Personal Biometric Data and Authenticating the User Based on the Encoded Biometric Data

### EXAMPLE 1

FIG. 6A shows an embodiment of a method by which the biometric access device 12 encodes the current biometric data that was acquired from the user 12 using the current reference time that was determined from the message 22 received from the mobile telephone network 18 on a mobile telephone control channel.

In accordance with this method, the biometric access device 12 generates a time-synchronized encryption key from the current reference time and a key code (block 80). The key code may be a unique code that is embedded in the biometric access device 12 and also is contained in the authentication authority 14. The biometric access device 12 executes an encryption key generating algorithm that combines and scrambles the current reference time and the key code to create a pseudorandom time-synchronized encryption key.

The biometric access device 12 encrypts the personal biometric data based on the time-synchronized encryption key (block 82). Any one of a wide variety of different types of symmetric key encryption methods (e.g., the Data Encryption Standard (DES) cryptographic method) may be used to encrypt the personal biometric data based on the time-synchronized encryption key.

The biometric access device 12 then transmits the encoded personal biometric data to the authentication authority 14 (block 83).

FIG. 6B shows an embodiment of a method by which the authentication authority 14 decodes the personal biometric data 38 that was encoded in accordance with the method of FIG. 6A and authenticates the user based on the second current reference time and the decoded personal biometric data.

In this embodiment, the authentication authority 14 receives the personal biometric data from the biometric access device (block 84).

The authentication authority 14 generates a second time-synchronized encryption key from the second current reference time and the key code (block 85). In this regard, the authentication authority 14 may select as the second current reference time the time the encoded biometric data is received or an earlier time that accounts for the transmission time delay as described above. The authentication authority 14 executes the same encryption key generating algorithm that was executed by the biometric access device 12. The encryption key generating algorithm combines and scrambles the second current reference time and the key code to create a second pseudorandom time-synchronized encryption key.

The authentication authority 14 decrypts the encrypted personal biometric data based on the second time-synchronized encryption key (block 86). The authentication authority 14 decrypts the personal biometric data using a symmetric key decryption method (e.g., the DES cryptographic method) that corresponds to the symmetric key encryption method that was used by the biometric access device 12 to encrypt the personal biometric data.

The authentication authority 14 authenticates the user 20 based on a comparison of the decrypted personal biometric data with previously registered biometric data (block 88). In this process, the authentication authority 14 may confirm that the decrypted biometric data matches a registered version of the biometric data that is associated with the user 20 or identify the user by selecting one of many previously registered biometric templates that best match the decrypted personal biometric data.

FIG. 6C shows an embodiment of a method by which the authentication authority 14 decodes the personal biometric data 38 that was encoded in accordance with the method of FIG. 6A and authenticates the user based on the second current reference time and the decoded personal biometric data. In this embodiment, the authentication authority 14 may select as the second current reference time a time that accounts for the transmission time delay between the time the personal biometric data 38 is transmitted by the biometric access device and the time the personal biometric data 38 is received by the authentication authority 14.

In this embodiment, the authentication authority 14 receives the personal biometric data from the biometric access device (block 90).

The authentication authority 14 generates a second time-synchronized encryption key from the second current reference time and the key code (block 92). The authentication authority 14 executes the same encryption key generating algorithm that was executed by the biometric access device 12. The encryption key generating algorithm combines and scrambles the second current reference time and the key code to create a second pseudorandom time-synchronized encryption key.

The authentication authority 14 decrypts the encrypted personal biometric data based on the second time-synchronized encryption key (block 94). The authentication authority 14 decrypts the personal biometric data using a symmetric key decryption method (e.g., the DES cryptographic method) that corresponds to the symmetric key encryption method that was used by the biometric access device 12 to encrypt the personal biometric data.

If the authentication authority 14 is able to successfully decrypt the personal biometric data (block 96), the authentication authority 14 authenticates the user 20 based on a comparison of the decrypted personal biometric data with previously registered biometric data (block 98). In this process, the authentication authority 14 may confirm that the decrypted biometric data matches a registered version of the biometric data that is associated with the user or identify the user by selecting one of many previously registered biometric templates that best match the decrypted personal biometric data.

If the authentication authority 14 is unable to successfully decrypt the personal biometric data (block 96), the authentication authority 14 determines whether the maximum accommodation time has been reached (block 100). The maximum accommodation time may be selected, for example, based on the expected transmission time delay and security considerations.

If the maximum accommodation time has not been reached (block 100), the authentication authority 14 decrements the second current reference time (block 102) and repeats the processes of generating the second time-synchronized encryption key (block 90) and attempting to decrypt the personal biometric data (block 94). If the maximum accommodation time has been reached (block 100), the authentication authority 14 reports that the authentication process has failed (block 104).

### EXAMPLE 2

FIG. 7A shows an embodiment of a method by which the biometric access device 12 encodes the current biometric data that was acquired from the user 12 using the current reference time that was determined from the message 22 received from the mobile telephone network 18 on a mobile telephone control channel.

In accordance with this method, the biometric access device 12 generates a time-synchronized authentication code from the current reference time and the personal biometric data (block 110). The biometric access device 12 executes an authentication code generating algorithm that combines and scrambles the current reference time and the personal biometric data to create a pseudorandom time-synchronized authentication code.

The biometric access device 12 transmits the time-synchronized authentication code to the authentication authority 14 as the encoded personal biometric data 38 (block 112).

FIG. 7B shows an embodiment of a method by which the authentication authority 14 authenticates the user 20 based on the second current reference time, the previously registered personal biometric data that is associated with the user 20, and the time-synchronized authentication code that was generated in accordance with the method of FIG. 7A.

In this embodiment, the authentication authority 14 receives the time-synchronized authentication code transmitted by the biometric access device 12 (block 114).

The authentication authority 14 then generates a second time-synchronized authentication code from the second current reference time and the previously registered personal biometric data that is associated with the user 20 (block 116).

In this regard, the authentication authority 14 may select as the second current reference time the time the encoded biometric data is received or an earlier time that accounts for the transmission time delay as described above. The authentication authority 14 executes the same authentication code generating algorithm that was executed by the biometric access device 12. The authentication code generating algorithm combines and scrambles the second current reference time and the previously registered personal biometric data to create a second pseudorandom time-synchronized authentication code.

The authentication authority 14 authenticates the user 20 based on a comparison of the first and second time-synchronized authentication codes (block 118). For example, if the first and second time-synchronized authentication codes match within a specified tolerance range, the authentication authority 14 transmits a signal confirming that the user 20 corresponds to the identity associated with the previously registered personal biometric data. If the first and second time-synchronized authentication codes do not match, the authentication authority 14 transmits a signal indicating that the user does not correspond to the identity associated with the previously registered personal biometric data.

IV. Conclusion

The embodiments that are described in detail above authenticate a user in ways that securely encode the user's personal biometric data with unique, dynamic, and precise current time information that is extracted from cellular control channel messages. The use of such unique, dynamic encoding of the user's personal biometric data significantly reduces the risk of theft. In addition, the infrastructure, protocols, processes, and messages containing the current time information already exist in many areas of the United States and other countries. Therefore, these embodiments readily may be implemented without requiring any changes to existing mobile telephone infrastructures, which provide essentially free access to the precise time information. These embodiments also may obtain the precise current time information using readily available and pervasive mobile telephone receivers, which are significantly less expensive than self-contained precision clock circuits and other types of receivers, such as GPS receivers.

Other embodiments are within the scope of the claims.

What is claimed is:

1. An authentication method, comprising:
receiving a message on a mobile telephone control channel;
determining a current reference time from the received message;
encoding personal biometric data of a user based on the current reference time; and
transmitting the encoded personal biometric data.

2. The method of claim 1, wherein the determining comprises determining the current reference time from a time set command in the received message.

3. The method of claim 1, wherein the determining comprises determining the current reference time from a coordinated universal time contained in the received message.

4. The method of claim 1, further comprising determining a second current reference time that is synchronized with the first current reference time.

5. The method of claim 4, wherein determining the second current reference time comprises determining a receipt time when the transmitted encoded personal biometric data is received and selecting a time earlier than the receipt time as the current reference time.

6. The method of claim 4, further comprising decoding the encoded personal biometric data based on the second current reference time.

7. The method of claim 6, further comprising authenticating the user based on a comparison of the decoded personal biometric data and previously registered personal biometric data.

8. The method of claim 6, wherein:
the encoding comprises generating a time-synchronized encryption key from the current reference time and a key code, and encrypting the personal biometric data based on the time-synchronized encryption key; and
the decoding comprises generating a second time-synchronized encryption key from the second current reference time and a copy of key code, and decrypting the encrypted personal biometric data based on the second time-synchronized encryption key.

9. The method of claim 1, wherein the encoding comprises generating a time-synchronized authentication code from the current reference time and the personal biometric data.

10. The method of claim 9, further comprising determining a second current reference time that is synchronized with the first current reference time, generating a second time-synchronized authentication code from the second current reference time and a copy of the personal biometric data, and authenticating the user based on a comparison of the first and second time-synchronized authentication codes.

11. The method of claim 1, further comprising acquiring the biometric data from a user.

12. An authentication system, comprising:
a receiver that receives a message on a mobile telephone control channel;
a processor that determines a current reference time from the received message and encodes personal biometric data based on the current reference time; and
a transmitter that transmits the encoded personal biometric data.

13. The system of claim 12, wherein the processor determines the current reference time from a time set command in the received message.

14. The system of claim 12, wherein the processor determines the current reference time from a coordinated universal time contained in the received message.

15. The system of claim 12, further comprising an authentication authority that determines a second current reference time that is synchronized with the first current reference time.

16. The system of claim 15, wherein the authentication authority determines the second current reference time by determining a receipt time when the transmitted encoded personal biometric data is received and selecting a time earlier than the receipt time as the current reference time.

17. The system of claim 15, wherein the authentication authority decodes the encoded personal biometric data based on the second current reference time.

18. The system of claim 17, wherein the authentication authority authenticates the user based on a comparison of the decoded personal biometric data and previously registered personal biometric data.

19. The system of claim 17, wherein:
the processor generates a time-synchronized encryption key from the current reference time and a key code, and encrypts the personal biometric data based on the time-synchronized encryption key; and
the authentication authority generates a second time-synchronized encryption key from the second current reference time and a copy of key code, and decrypts the encrypted personal biometric data based on the second time-synchronized encryption key.

20. The system of claim 12, wherein the processor generates a time-synchronized authentication code from the current reference time and the personal biometric data.

21. The system of claim 20, further comprising an authentication authority that determines a second current reference time that is synchronized with the first current reference time, generates a second time-synchronized authentication code from the second current reference time and a copy of the personal biometric data, and authenticates the user based on a comparison of the first and second time-synchronized authentication codes.

22. The system of claim 12, further comprising a sensor operable to acquire a biometric pattern from a user, and wherein the processor generates the biometric data from the acquired biometric pattern.
